(19) United States
(12) Patent Application Publication
(10) Pub. No.: US 2003/0018463 A1
(43) Pub. Date: Jan. 23, 2003

(54) Logical simulation method

(76) Inventor: Toshihiro Matsuo, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/175,956

(22) Filed: Jun. 21, 2002

(30) Foreign Application Priority Data
Jun. 21, 2001 (JP) 2001-188569

(51) Int. Cl. G06F 17/50

(52) U.S. Cl. 703/19; 703/14

(57) ABSTRACT

There is disclosed a logical simulation method, comprising the steps of: executing simulation of 1 cycle; and proceeding to the execution of simulation for a next cycle without displaying a waveform indicating the simulation result of a cycle if the cycle is one for turning OFF a waveform display.

### BACKGROUND OF THE INVENTION

1. Field of the Invention

This invention relates to a logical simulation method for simulating a synchronous sequential circuit such as a microcomputer or the like.

2. Description of the Related Art

Logical simulation is performed to verify whether or not the operation of a logical circuit is correct.

A synchronous sequential circuit operated in synchronism with a clock signal like the one shown in FIG. 10 simulates a calculation of the signal value of the circuit and so on, wherenever a clock signal is entered. To facilitate understanding of a simulation result, in most cases, a simulator is provided with a function of displaying the result in the form of a timing waveform like the one shown in FIG. 11.

Because of the foregoing constitution of the conventional logical simulation method, even when there is a cycle unnecessary to be observed, the simulation result of the cycle unnecessary to be observed is also displayed in a waveform. Consequently, there has been a difficulty in searching a clock cycle to be observed among displayed waveforms, in a case where the period of the cycle unnecessary to be observed is long, in a case where cycles unnecessary to be observed periodically appear or the like.

In addition, even for the cycles unnecessary to be observed, simulation is carried out for each cycle as in the case of the other cycles. Consequently, there has been such a problem that a long time is required for the execution of simulation in a case where the period of unnecessary observation is long.

### SUMMARY OF THE INVENTION

The present invention has been made to solve the foregoing problems, and it is an object of the invention to provide a logical simulation method for quickly verifying the simulation result of a cycle to be observed.

It is another object of the invention to provide a logical simulation method for shortening a simulation time.

In accordance with invention, there is provided a logical simulation method, comprising the steps of: specifying one cycle after the cycles whose waveform display is to be set to ON and those whose waveform display is to be set to OFF are designated; and displaying a waveform indicating the simulation result of the cycle if the cycle is the one whose waveform display is to be set to ON, and proceeding to execution of simulation for the next cycle, alternatively proceeding to the execution of simulation for the next cycle without displaying the simulation result of the cycle if the cycle is the one whose waveform display is to be set to OFF.

In accordance with invention, there is provided a logical simulation method, comprising the steps of: executing simulation for all cycles; saving their simulation results in a log file; extracting, when the cycles whose waveform display is to be set to ON and those whose waveform display is to be set to OFF are designated, only the simulation results of the cycles whose waveform display is to be set to ON from the log file, and displaying the waveforms indicating the simulation results.

According to each of the above logical simulation methods of the invention, in accepting the designation of the cycle whose waveform display is to be set to ON and that of those whose waveform display is to be set to OFF, the waveform display is switched to another by accepting plural kinds of designations having mutually different combinations of ON and OFF cycles.

In accordance with the invention, there is provided a logical simulation method, comprising the steps of: forming a circuit model for collectively executing simulation for a plurality of cycles based on the information of a simulation target circuit; and executing simulation for continuous cycles unnecessary to be observed by using the circuit model.

According to the logical simulation method of the invention, when the simulation is executed for the continuous cycles unnecessary to be observed by using the circuit model, calculation is carried out from the later one in terms of simulation time.

According to the logical simulation method of the invention, the circuit model is mapped in hardware.

### BRIEF DESCRIPTION OF THE DRAWINGS

FIG. 1 is a flowchart showing a logical simulation method according to a first embodiment of the present invention.

FIG. 2 is a waveform chart showing a case in which waveforms including the cycles unnecessary to be observed are displayed.

FIG. 3 is a waveform chart showing a case in which waveforms excluding the cycles unnecessary to be observed are displayed.

FIG. 4 is a flowchart showing a logical simulation method according to a second embodiment of the invention.

FIG. 5 is a waveform chart showing a case in which a set of a plurality of cycles can be designated to be displayed or not are displayed.

FIG. 6 is an explanatory view showing a method of forming a circuit designed to carry out simulation collectively.

FIG. 7 is a circuit diagram showing a circuit for executing processing of two cycles collectively.

FIG. 8 is an explanatory view showing a metho of calculating a logical function.

FIG. 9 is an explanatory view showing a mapping example of a circuit model.

FIG. 10 is a circuit diagram showing a synchronous sequential circuit.

FIG. 11 is a waveform chart showing timing waveforms.

### DETAILED DESCRIPTION OF THE PREFERRED EMBODIMENTS

Next, the preferred embodiments of the present invention will be described.

(First Embodiment)

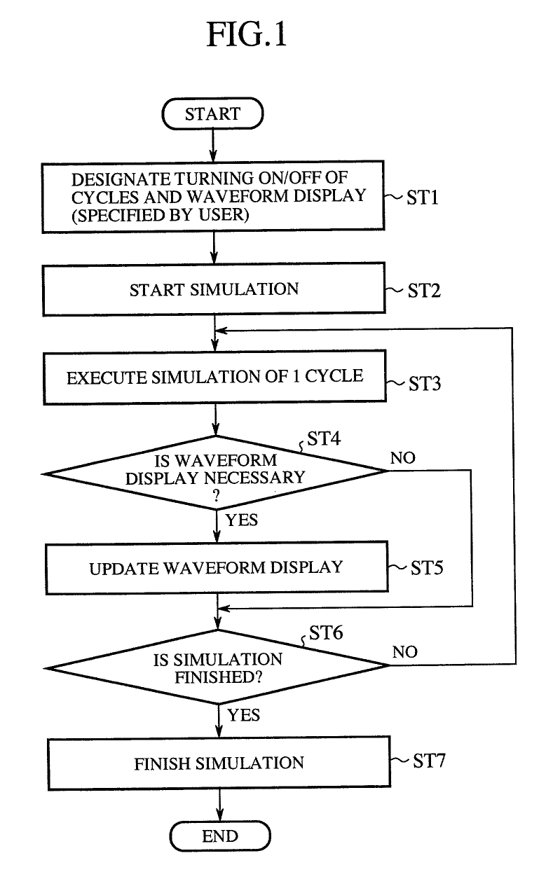

FIG. 1 is a flowchart showing a logical simulation method according to a first embodiment of the invention. In the drawing, ST1 denotes a designation step for designating the cycles whose waveform display is to be set to ON or to OFF; ST2 an execution starting step for starting the execution of simulation; ST3 an executing step for executing simulation of 1 cycle; ST4 a determination step for determining the necessity of a waveform display; ST5 an updating step for updating a waveform display; ST6 a determination step for determining the end of simulation; and ST7 a finishing step for finishing simulation.

Next, an operation will be described.

First, a logical simulator, not shown, receives from a user the designation of the cycles whose waveform display is to be set to ON and of those whose waveform display is to be set to OFF (step ST1). For example, if the waveform display of 3rd to 5th cycles among 1st to 7th cycles is not necessary, designation to turn OFF the 3rd to 5th cycles and turn ON the other cycles is received.

Upon receiving the ON/OFF designation of the waveform display, the logical simulator starts execution of the simulation (step ST2), and executes the simulation of 1 cycle (step ST3).

Then, the logical simulator determines whether each cycle corresponds to the one whose waveform display is to be set to ON or OFF by referring to the designated content (step ST4).

If the cycle corresponds to the one whose waveform display is to be set to ON, a waveform indicating the simulation result of the cycle is displayed (step ST5), and the process proceeds to step ST6. On the other hand, if the cycle corresponds to the one whose waveform display is to be set to OFF, then the process proceeds to step ST6 without executing the waveform displaying of the simulation result.

Thereafter, the process from step ST3 to ST5 is repeatedly executed until simulation is finished for all the cycles (steps ST6 and ST7).

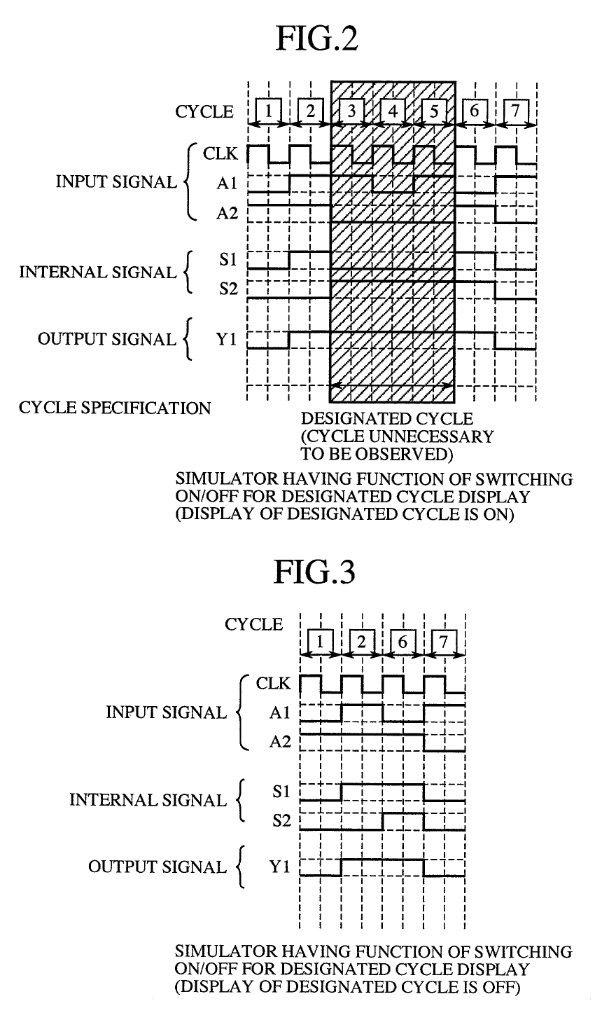

Here, FIG. 2 is a waveform chart showing the case in which waveforms including the cycles unnecessary to be observed and displayed; and FIG. 3 a waveform chart showing the case in which waveforms excluding the cycles unnecessary to be observed are displayed.

As described above, according to the first embodiment, the simulation of 1 cycle is carried out and, if the cycle corresponds to the one whose waveform display is to be set to ON, a waveform indicating the simulation result of the cycle is displayed, and then the process proceeds to the execution of simulation for a next cycle. On the other hand, if the cycle corresponds to the one whose waveform display is to be set to OFF,, the process proceeds to the execution of simulation for the next cycle without displaying the waveform of the simulation result. Thus, it is possible to quickly verify the simulation result of the cycle to be observed.

(Second Embodiment)

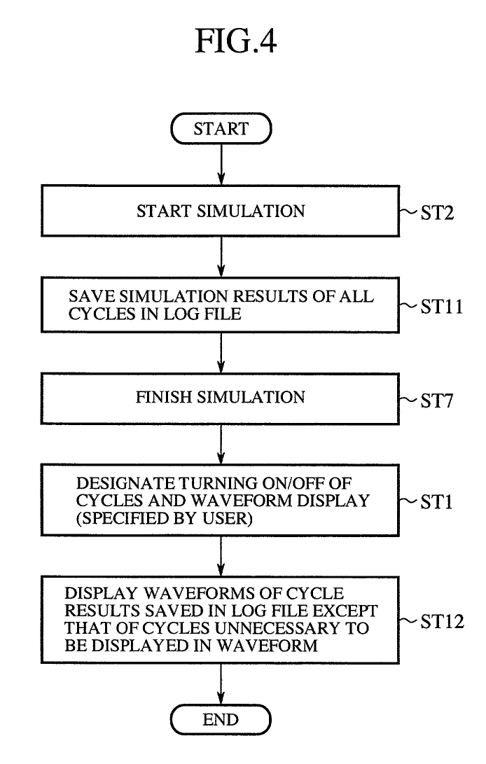

In the foregoing first embodiment, each time the simulation for one cycle is executed, the determination is made as to whether the thus simulated cycle corresponds to the one whose waveform is to be set to ON or OFF. However, a logical simulation method may be constituted in the following manner. That is, as shown in FIG. 4, the method comprises: executing simulation for all the cycles first, and then saving the simulation results thereof in a log file (step ST11: saving step); designating the cycles whose waveform display is to be set to ON or OFF (step ST1); and extracting only the cycles whose waveform display is to be set to ON from the log file (excluding those whose waveform display is to be set to OFF) from the simulation results, and then displaying a waveform indicating the extracted simulation results (step ST12: displaying step).

(Third Embodiment)

In the foregoing first and second embodiments, only one kind of designation for turning ON/OFF the waveform display is accepted, (that is, although a plurality of cycles can be designated, only one kind can be designated as a set of cycles which are not necessarily continuous). However, a waveform display may be switched to another by accepting plural kinds of designations, in which the combinations of ON and OFF cycles are different from each other.

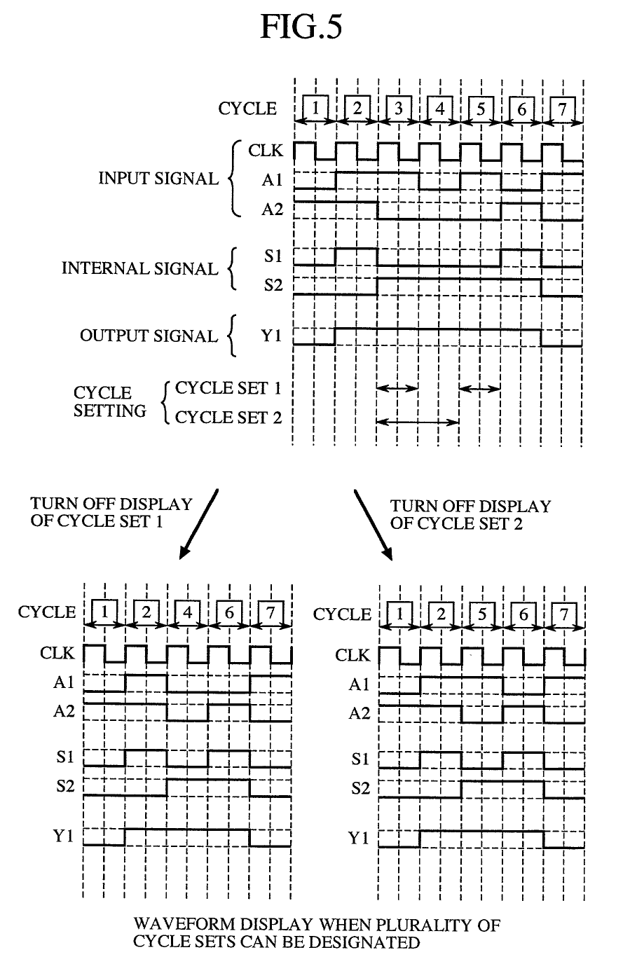

That is, as shown in FIG. 5, plural kinds of cycle sets can be set, and the waveform displaying of cycles unnecessary to be observed is prevented for each kind of designated cycles.

Thus, if there are plural kinds of cycles unnecessary to be observed, the waveform of only the cycles to be observed can be displayed according to the kinds of those cycles necessary to be observed. As a result, it is possible to switch the waveform display of the cycle to be observed to another only by changing the designation of the kind of cycles.

(Fourth Embodiment)

Though no particular mention is made in the foregoing first to third embodiments, a circuit model for collectively executing simulation of a plurality of cycles based on the information of a simulation target circuit may be formed, and simulation may be carried out for continuous cycles unnecessary to be observed by using this circuit model.

Specifically, such a circuit model is formed as follows.

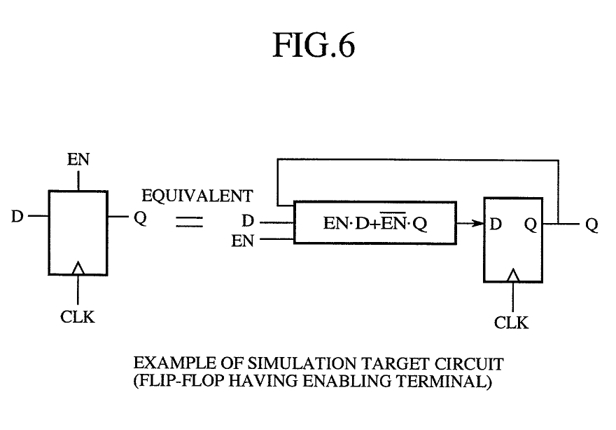

FIG. 6 shows the method of forming a circuit for collectively carrying out simulation for a plurality of continuous cycles based on the information of a simulation target circuit.

Now, description will be made as to the case where the circuit of FIG. 6 (flip-flop equipped with an enabling terminal) is provided as a simulation target circuit. This circuit captures, when EN is “1”, the signal of a terminal D into a terminal Q at the rising of a clock CLK, and holds the value of the terminal Q when EN is “0”.

If the value of the k-cycle of a signal X in the circuit is X(k), then the operation of the circuit can be represented by the following logical function (A·B indicates “AND” operation between A and B; A+B indicates “OR” operation between A and B; and \overline{A} indicates negative A)

Q(k+1)=EN(k)·D(k)+\overline{EN(k)}·Q(k) (1)

Based on the equation (1), the value of the terminal Q after 1 cycle can be calculated from the value of a previous signal.

By repeatedly applying the equation (1), the value of the terminal Q after 2 cycles can be calculated from the value of a previous signal.

$$\begin{matrix}Q ( k + 2 ) = EN ( k + 1 ) \cdot D ( k + 1 ) + \overline{EN ( k + 1 )} \cdot Q ( k + 1 ) \\ = EN ( k + 1 ) \cdot D ( k + 1 ) + \\ \overline{EN ( k + 1 )} \cdot ( EN ( k ) \cdot D ( k ) + \overline{EN ( k )} \cdot Q ( k ) )\end{matrix} \qquad ( 2 )$$

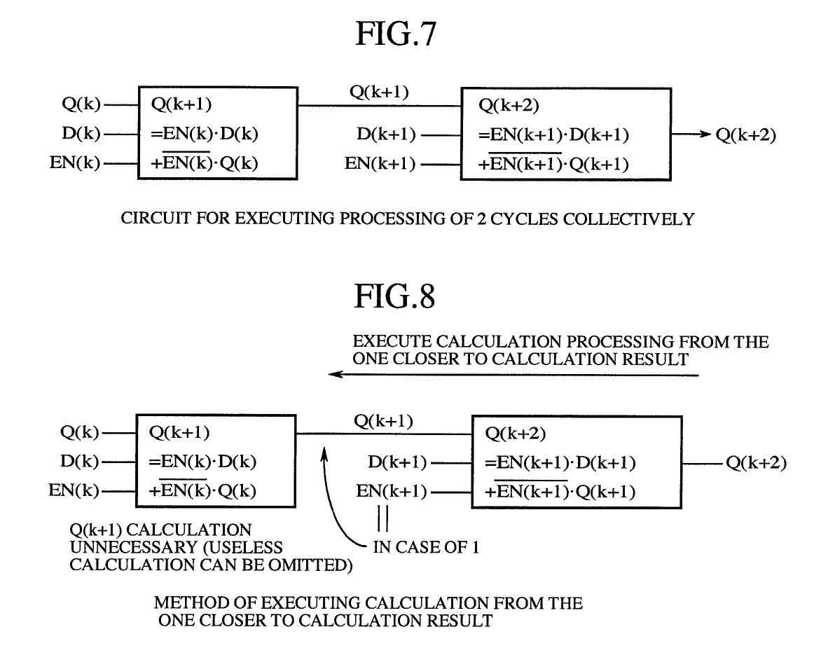

FIG. 7 shows a circuit model representing this logical function, and specifically a circuit for collectively executing processing of 2 cycles.

Similarly, it is possible to form a circuit model for collectively executing processing of the optional number of cycles.

In such circuits, as shown in FIG. 8, useless calculation can be omitted (calculation of Q(k+1) becomes unnecessary) by executing calculation from the one closer (the later simulation in terms of time) to a calculation result (Q(k+2)). Thus, calculation can be performed efficiently.

As described above, according to the fourth embodiment, a circuit model is formed for collectively executing simulation for a plurality of cycles based on the information of a simulation target circuit, and simulation is carried out for the continuous cycles unnecessary to be observed. As a result, it is possible to shorten a simulation time.

(Fifth Embodiment)

In the foregoing fourth embodiment, the logical simulator executes simulation for continuous cycles unnecessary to be observed by using a circuit model. However, the circuit model may be mapped in hardware, and the logical simulator then feeds an input sequence of simulation to the hardware.

A specific constitution is as follows.

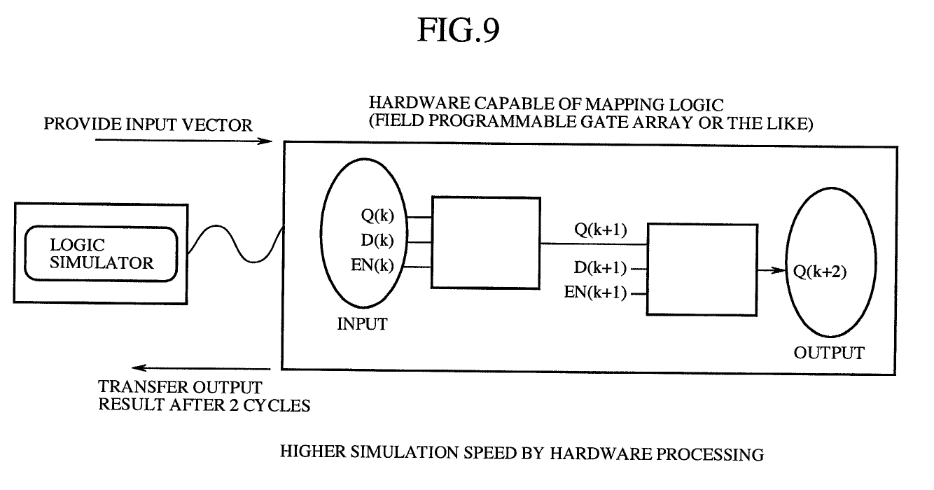

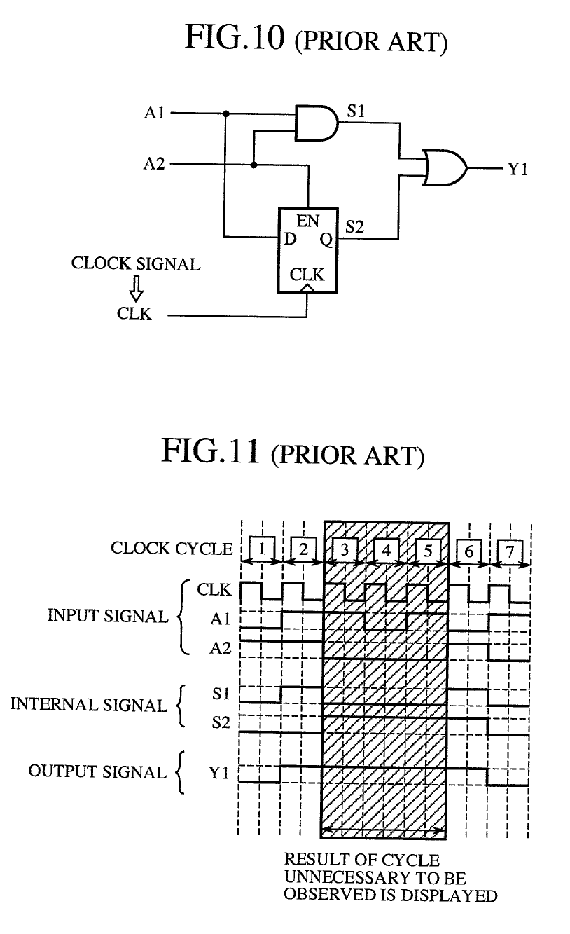

As shown in FIG. 9, the circuit of FIG. 7, formed according to the fourth embodiment, is prepared on a device (hardware) capable of mapping the logic of a field programmable gate array or the like. The logical simulator feeds an input sequence of simulation to the device.

On the device, high-speed calculation is executed for the results of such inputs, and the calculation results are received by the logical simulator. Thus, a simulation time can be shortened.

As apparent from the foregoings, the present invention is advantageous in the following respects.

The simulation of 1 cycle is executed and, if the cycle is the one whose waveform display is set to be ON, a waveform indicating the simulation result of the cycle is displayed, and the process proceeds to the execution of simulation for the next cycle. On the other hand, if the cycle is the one whose waveform display is set to be OFF, the process proceeds to the execution of simulation for the next cycle without displaying a waveform indicating the simulation result of the cycle. Thus, it is possible to quickly verify the simulation result of a cycle to be observed.

After the cycles whose waveform display is to be set to ON and those whose waveform display is to be set to OFF are designated, only the simulation result of the cycles whose waveform display is to be set to ON are extracted from the log file, and the waveforms indicating the simulation result thereof are displayed. Thus, it is possible to quickly verify the simulation result of the cycle to be observed.

When accepting the designation of cycles whose waveform display is to be set to ON and that of those whose waveform display is to be set to OFF, plural kinds of designations, in which the combinations of ON and OFF cycles are different from each other, are accepted, thereby switching the waveforms to be displayed to another. Thus, it is possible to switch a waveform display to another for the cycles to be observed.

A circuit model is formed for collectively executing simulation for a plurality of cycles based on the information of the simulation target circuit, and simulation is carried out for continuous cycles unnecessary to be observed by using the circuit model. Thus, it is possible to shorten a simulation time.

When simulation is carried out for the continuous cycles unnecessary to be observed by using a circuit model, calculation is executed from the later one in terms of simulation time. Thus, it is possible to perform calculation efficiently.

Since the circuit model is mapped in the hardware, it is possible to further shorten the simulation time.

What is claimed is:

1. A logical simulation method comprising the steps of:
specifying one cycle after the cycles whose waveform display is to be set to ON and those whose waveform display is to be set to OFF are designated; and
displaying a waveform indicating the simulation result of the cycle if the cycle is the one whose waveform display is to be set to ON, and proceeding to execution of simulation for the next cycle, alternatively proceeding to the execution of simulation for the next cycle without displaying the simulation result of the cycle if the cycle is the one whose waveform display is to be set to OFF.

2. A logical simulation method comprising the steps of:
executing simulation for all cycles;
saving their simulation results in a log file;
extracting, when the cycles whose waveform display is to be set to ON and those whose waveform display is to be set to OFF are designated, only the simulation results of the cycles whose waveform display is to be set to ON from the log file, and displaying the waveforms indicating the simulation results.

3. A logical simulation method according to claim 1, wherein in accepting the designation of the cycle whose waveform display is to be set to ON and that of those whose waveform display is to be set to OFF, the waveform display is switched to another by accepting plural kinds of designations having mutually different combinations of ON and OFF cycles.

4. A logical simulation method according to claim 2, wherein in accepting the designation of the cycle whose waveform display is to be set to ON and that of those whose waveform display is to be set to OFF, the waveform display is switched to another by accepting plural kinds of designations having mutually different combinations of ON and OFF cycles.

5. A logical simulation method comprising the steps of:
forming a circuit model for collectively executing simulation for a plurality of cycles based on the information of a simulation target circuit; and
executing simulation for continuous cycles unnecessary to be observed by using the circuit model.

6. A logical simulation method according to claim 5, wherein when the simulation is executed for the continuous cycles unnecessary to be observed by using the circuit model, calculation is carried out from the later one in terms of simulation time.

7. A logical simulation method according to claim 5, wherein the circuit model is mapped in hardware.
